(19) United States
(12) Patent Application Publication
(10) Pub. No.: US 2023/0152814 A1
(43) Pub. Date: May 18, 2023

(54) System Of Cooperating With Multiple Navigation Robots For Cross-Floor Guidance Based On Time And Method Thereof

(71) Applicants: SQ Technology (Shanghai) Corporation, Shanghai (CN); Inventec Corporation, Taipei City (TW)

(72) Inventors: Chuan-Cheng Chiu, Taipei City (TW); Zhou-Jia Bian, Shanghai (CN)

(21) Appl. No.: 17/693,746

(22) Filed: Mar. 14, 2022

(30) Foreign Application Priority Data
Nov. 18, 2021 (CN) 202111368323.2

(51) Int. Cl. G05D 1/02; G05D 1/12

(52) U.S. Cl. CPC G05D 1/0217; G05D 1/028; G05D 1/0287; G05D 1/12

(57) ABSTRACT

A system of cooperating with multiple navigation robots for cross-floor guidance based on time and a method thereof are disclosed. In the system, a first navigation robot evaluates a movement time of a service target from a first floor to a second floor, generates a task message based on the movement time, and guides the service target on the first floor based on a first navigation route; a second navigation robot obtains a target arrival time contained in the task message and determines a delay time for reaching a floor entry area of the second floor earlier than the target arrival time, so that the first navigation robot can postpone the time of guiding the service target to a floor departure area of the first floor based on the delay time.

### BACKGROUND OF THE INVENTION

### 1. Field of the Invention

The present invention is related to a cross-floor multiple-navigation-robot guidance system and a method thereof, and more particularly to a system of cooperating with multiple navigation robots for cross-floor guidance based on time, and a method thereof.

### 2. Description of the Related Art

With the emergence of indoor map service systems, the need for route guidance between multi-floor maps appears. Indoor maps usually include multiple floor maps with a connection relationship therebetween, so the cross-map route calculation between a starting point and a target point of different floor maps is needed.

In addition to the simple route calculation, indoor cross-floor guidance also has the problem in movement of the robot between floors; in recent years, only precision-made navigation robot is possible to independently move between floors but the cost of the guidance solution is very high, so most indoor cross-floor guidance solutions still use multiple navigation robots. That is, different navigation robots are disposed on different floors, respectively, and each navigation robot is used to navigate the floor where it is disposed.

However, in the above-mentioned indoor cross-floor guidance solution, there is no effective communication mechanism for the navigation robots on different floors, and it easily leads to a situation that a service target must wait a navigation robot of a target floor after moving between floors to reach the target floor but no navigation robot is ready to guide.

Therefore, what is needed is to develop an improved technical solution to solve the conventional technology problem of lacking a cooperative communication mechanism for the navigation robots on different floors.

### SUMMARY OF THE INVENTION

An objective of the present invention is to disclose a system of cooperating with multiple navigation robots for cross-floor guidance based on time and a method thereof, so as to solve the conventional technology problem of lacking a cooperative communication mechanism for the navigation robots on different floors.

In order to achieve the objective, the present invention is to provide a system of cooperating with multiple navigation robots for cross-floor guidance based on time, and the system includes a first navigation robot and a second navigation robot. The first navigation robot is configured to obtain guidance data of a service target, wherein the guidance data comprises a first guidance message of a first floor, and a second guidance message of a second floor, and the first navigation robot generates a first navigation route based on the first guidance message, evaluates a first movement time of the service target from the first floor to the second floor based on the first navigation route and a floor amount between the first floor and the second floor, and generate a first task message based on the first movement time and the second guidance message, and guides the service target on the first floor based on the first navigation route. The second navigation robot is configured to receive the first task message transmitted from the first navigation robot, obtain a target arrival time contained in the first task message, and determine whether it is able to reach a floor entry area of the second floor earlier than the target arrival time, calculate and transmit a delay time to the first navigation robot, so that the first navigation robot postpones a time of guiding the service target to a floor departure area of the first floor based on the delay time, wherein the second navigation robot moves to a floor entry area of the second floor, and guides the service target on the second floor based on a second navigation route generated by the second guidance message, after arrival of the service target.

In order to achieve the objective, the present invention is to provide a method of cooperating with multiple navigation robots for cross-floor guidance based on time, and the method includes steps of: obtaining guidance data of a service target, by a first navigation robot of a first floor, wherein the guidance data comprises a first guidance message of the first floor and a second guidance message of a second floor; generating a first navigation route based on the first guidance message, and evaluating a first movement time of the service target from the first floor to the second floor based on the first navigation route and a floor amount between the first floor and the second floor, generating a first task message based on the first movement time and the second guidance message, and transmitting the first task message to a second navigation robot of the second floor, by the first navigation robot; obtaining a target arrival time in the first task message, by the second navigation robot wherein when the second navigation robot determines that it is unable to reach a floor entry area of the second floor earlier than the target arrival time, the second navigation robot calculates a delay time and transmits the delay time to the first navigation robot; guiding the service target on the first floor based on the first navigation route, by the first navigation robot, wherein when the first navigation robot receives the delay time, the first navigation robot postpones a time of guiding the service target to a floor departure area of the first floor based on the delay time; moving the second navigation robot to a floor entry area of the second floor; after arrival of the service target on the second floor, guiding the service target on the second floor based on a second navigation route generated by the second guidance message, by the second navigation robot.

According to the above-mentioned system and method of the present invention, the difference between the present invention and the conventional technology is that the first navigation robot evaluates the first movement time of the service target from the first floor to the second floor based on the first navigation route of the first floor and the floor amount between the first floor and the second floor, and generates the first task message based on the first movement time and the second guidance message of the second floor, and guides the service target on the first floor; the second navigation robot obtains the target arrival time contained in the first task message, calculates and transmits the delay time to the first navigation robot when determining that it is unable to reach the floor entry area of the second floor earlier than the target arrival time, so that the first navigation robot can postpone the time of guiding the service target to the floor departure area of the first floor based on the delay time; when the second navigation robot determines that the service target reaches the second floor, the second navigation robot guides the service target on the second floor based on the second navigation route generated by the second guidance message. As a result, the above-mentioned technical solution of the present invention can solve the conventional technology problem to achieve the technical effect of shortening the guidance waiting time for the service target.

### BRIEF DESCRIPTION OF THE DRAWINGS

The structure, operating principle and effects of the present invention will be described in detail by way of various embodiments which are illustrated in the accompanying drawings.

FIG. 1A a structural view of a system of cooperating with multiple navigation robots for cross-floor guidance based on time, according to the present invention.

FIG. 1B another structural view of a system of cooperating with multiple navigation robots for cross-floor guidance based on time, according to the present invention.

FIG. 2A is a flowchart of a method of cooperating with multiple navigation robots for cross-floor guidance based on time, according to the present invention.

FIG. 2B is a flowchart showing an operation of generating a time adjustment message by a first navigation robot, according to the present invention.

FIG. 2C is a flowchart of an optional process of a method of cooperating with multiple navigation robots for cross-floor guidance based on time, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The present invention can be applied to multiple-floor environment to enable the navigation robots on different floors to interact with each other, so that the service target can be immediately guided by the navigation robot on a target floor when the service target reaches the target floor.

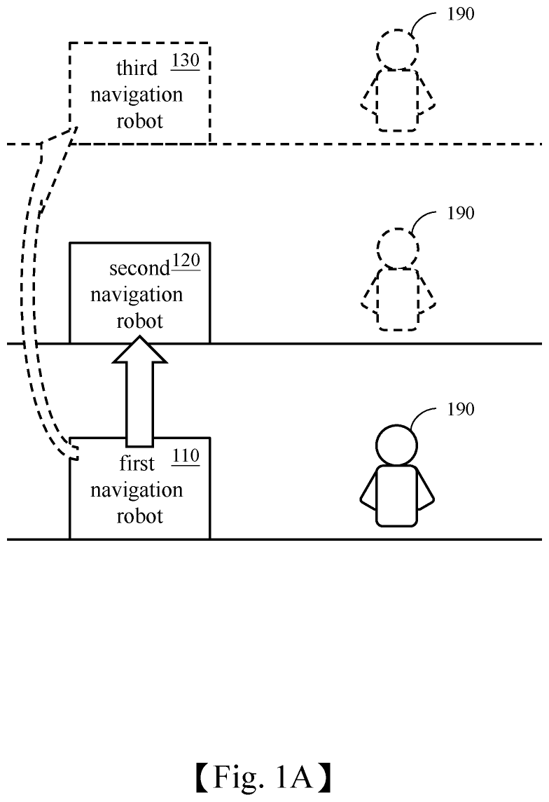

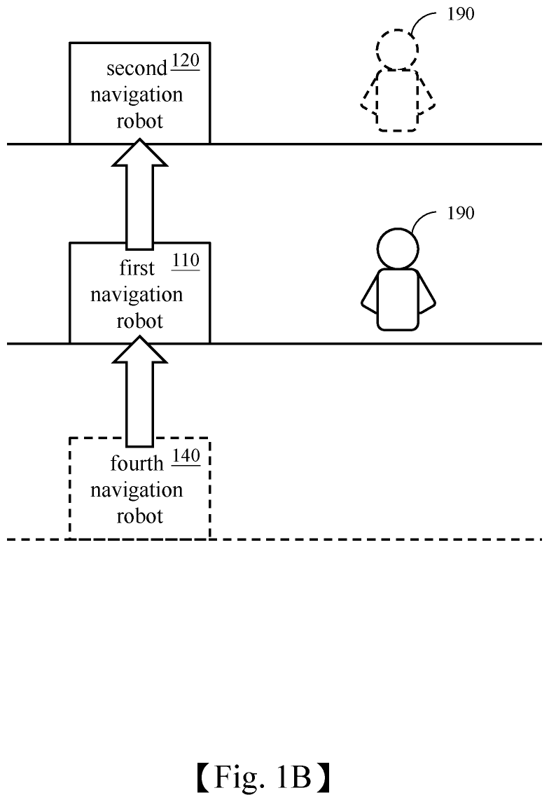

Please refer to FIG. 1A, which is a structural view of a system of cooperating with multiple navigation robots for cross-floor guidance based on time, according to the present invention. As shown in FIG. 1A, the system of the present invention includes multiple first navigation robots 110, multiple second navigation robots 120, and multiple third navigation robots 130. The third navigation robot 130 is optional in the system. The first navigation robot 110, the second navigation robot 120, the third navigation robot 130 can be connected with each other to wirelessly transmit data or signals. The first navigation robot 110, the second navigation robot 120 and the third navigation robot 130 are computing apparatuses with autonomous mobility.

The first navigation robot 110 is disposed on the first floor, and configured to obtain guidance data of a service target 190. In more detail, the first navigation robot 110 provides the service target 190 to input the location to be visited, and the inputted location is also referred to as a scheduled stay point in the present invention; or the first navigation robot 110 can receive the location, which is inputted by the service target 190, from a navigation setting device (not shown in figures). The first navigation robot 110 generates guidance data including the location inputted by the service target 190. The scheduled stay point can be anitem (ex. an object or a place) to be visited by the service target 190 or a service window of an item to be handled by service target 190; however, the present invention is not limited to these examples.

The guidance data obtained by the first navigation robot 110 includes a guidance message of the floor where the first navigation robot 110 is disposed, and a guidance message of other floor to be visited by the service target 190. For example, when the service target 190 is to visit the second floor and the third floor, the guidance data includes a first guidance message of a first floor, a second guidance message of the second floor, and a third guidance message of the third floor.

It is to be noted that each guidance message may contain the information of at least one stay point (but the guidance message of the first floor may have no information of the stay point), and the guidance data at least includes at least one of the information of one of the stay point. The information of each stay point can indicates the information about a scheduled stay point and include, but not limited to, properties of the to-be-visited item (such as author, type, year/decade), or properties of the item to be handled by the service target 190.

The first navigation robot 110 applies a conventional navigation route generation manner to generate a first navigation route based on the message of the stay point contained in the obtained first guidance message, and evaluates a time of the service target 190 moving from the first floor to the second floor based on the generated first navigation route and a floor amount between the first floor and second floor. For example, the first navigation robot 110 can define an expected stay time for each stay point, or generate the expected stay time for each stay point based on statistics of the practical stay times of other service targets at each stay point in the past; the first navigation robot 110 can define an expected movement time of passing through single floor, or generate the expected movement time of passing through single floor based on statistics of the practical movement times of other service targets passing through single floor in the past. As a result, the first navigation robot 110 can sum up the expected stay time of the scheduled stay point on the first navigation route and the expected movement time of moving from the first and the second floor, to generate the scheduled stay time, and generate a first movement time including a guidance starting time (that is, the current time) and a scheduled stay time; for example, when the first navigation route includes two scheduled stay points, the expected stay times for the two scheduled stay points are three minutes and five minutes, respectively, and the expected movement time of passing through single floor is 2.5 minutes based on statistics, when the first floor is the first building floor (such as ground floor) and the second floor is the third building floor, the scheduled stay time is calculated as thirteen minutes (that is, 3+5+2.5*2=13); however, the manner of evaluating the first movement time by the first navigation robot 110 is not limited to above-mentioned example.

The first navigation robot 110 also generates the first task message based on the evaluated first movement time and the guidance message of other floor to be visited by the service target 190. For example, the first navigation robot 110 can generate the first task message including the first movement time and the second guidance message, but the present invention is not limited thereto.

The first navigation robot 110 can detect a movement speed of the service target 190 on the first floor (such as the movement speed of the first navigation robot 110 when the first navigation robot 110 guides the service target 190), or detect a forward speed of the service target 190, so as to obtain the movement speed of the service target 190 on the first floor.

The first navigation robot 110 can detect or predict the movement speed of the service target 190 from the first floor to the second floor. For example, when the service target 190 moves from the first floor to the second floor by taking an elevator, the first navigation robot 110 can detect a speed of the elevator through a speed sensor disposed on the elevator, and use the speed of the elevator as the movement speed of the service target 190 between floors; when the service target 190 walks from the first floor to the second floor through a stairwell, the first navigation robot 110 can recognize the service target 190 moving in the stairwell by a face recognizing device, which is a computing apparatus with a face recognition function, and calculate the movement speed of the service target 190 between floors based on a period in which the service target 190 passes two sensing points; or the first navigation robot 110 can determine a practical position of the service target 190 by using a conventional indoors positioning technology or signal sensors disposed in the stairwell to detect a wearable device (such as a bracelet with a tracker or a signal transmitter) worn on the service target 190, so as to calculate the movement speed of the service target 190 moving between floors, based on the practical position of the service target 190 and the period in which the service target 190 passes two sensing points. In an embodiment, the first navigation robot 110 can predict the movement speed of the service target 190 moving between floors based on the speed of the service target 190 walking on the first floor and/or age of the service target 190; however, the manner of detecting or predicting the movement speed between floors by the first navigation robot 110 is not limited to above-mentioned examples.

The first navigation robot 110 calculates the practical stay time of the stay point, which the service target 190 has visited, on the first navigation route; the stay point can include at least one of a scheduled stay point and an exceptional stay point.

The first navigation robot 110 can obtain the location information about the scheduled stay point on the first navigation route. The location information can correspond to a specific stay point. The first navigation robot 110 can obtain the location information about other stay point having property the same as or associated with the property of the stay point, or the first navigation robot 110 can obtain the location information about other stay point which was also visited by most of the service targets, who visited the stay point in the past; however, the manner of obtaining the location information by the first navigation robot 110 is not limited to above-mentioned examples.

The first navigation robot 110 can generate a time adjustment message based on at least one of the detected movement speed on the floor and detected movement speed between floors.

When the practical stay time of the service target 190 at the scheduled stay point on the first floor is different from the expected stay time or the stay point is different from the scheduled stay point on the first navigation route, the first navigation robot 110 generates a time adjustment message including an adjust time based on the practical stay time of the service target 190 at the stay point and/or the location information about the stay point. For example, when the stay time of the service target 190 at the scheduled stay point with specific property is longer (or shorter), the first navigation robot 110 can increase (or decrease) the expected stay time for the other scheduled stay point which is not visited by the service target 190 and has the same property on the first navigation route; for example, the first navigation robot 110 can increase (or decrease) the expected stay time by an average of the extended (or shorted) time differences for the service target 190; however, the present invention is not limited to these examples; in addition, the first navigation robot 110 can check whether there is any other item having the same properties on the first navigation route, and when there is an item which is not visited and has the same property on the first navigation route, the first navigation robot 110 can predict the item as an exceptional stay point, and increase the adjustment time by the expected stay time for the exceptional stay point.

The first navigation robot 110 transmits the generated time adjustment message to the second navigation robot 120. The time adjustment message generated by the first navigation robot 110 indicates the time when the service target 190 reaches the second floor earlier or later.

The first navigation robot 110 is configured to guide the service target 190 on the first floor based on the first navigation route, so as to guide the service target 190 to the scheduled stay point. After the service target 190 visits the all scheduled stay points, the first navigation robot 110 guides the service target 190 to a floor departure area of the first floor. In an embodiment, the floor departure area can be, for example, an elevator entrance, an escalator entrance, or a stairwell entrance.

The first navigation robot 110 receives the delay time transmitted from the second navigation robot 120; when all of received delay times are not zero, the first navigation robot 110 selects the shortest one of the received delay times, and postpones the time of guiding the service target 190 to the floor departure area of the first floor based on the selected delay time. For example, the first navigation robot 110 can reduce the movement speed of guiding the service target 190; or, the first navigation robot 110 can guide the service target 190 along a longer route, for example, the first navigation robot 110 can guide the service target 190 to take a detour, or move to another stay point which was visited by a certain amount of service targets who visited the at least one scheduled stay point in the past, or move to another stay point which has the same property or associated property and is not scheduled in the first navigation route; however, the present invention is not limited to examples.

The first navigation robot 110 can select a second navigation robot 120 which transmits a delay time is shortest. When value of one or more received delay times are zero, the first navigation robot 110 can select one of the second navigation robot 120 which transmits the delay time with a value of zero; or, when all of received delay times are not zero, the first navigation robot 110 can select the second navigation robot 120 which transmits the shortest delay time, when there are multiple shortest delay times, the first navigation robot 110 can select any one of the second navigation robots 120 transmitting the shortest delay times. The first navigation robot 110 also generates and transmits the service instruction message to the selected second navigation robot 120.

The first navigation robot 110 also receives the guidance starting message transmitted from the second navigation robot 120. After receiving the guidance starting message transmitted from the second navigation robot 120, the first navigation robot 110 evaluates a second movement time of the service target 190 from the second floor to the third floor based on a second navigation route and the floor amount between the second floor and the third floor in the second guidance message, and generates a second task message based on the second movement time and the third guidance message, and transmits the second task message to a third navigation robot 130 of the third floor. The above-mentioned manner of evaluating the second movement time and generating the second task message is the same as or similar to the manner of evaluating the first movement time and generating the first task message, so the detailed description is not repeated herein.

The second navigation robot 120 is disposed on the second floor, and configured to receive the first task message transmitted from the first navigation robot 110, and obtain a target arrival time based on the received first task message. In general, the first movement time contained in the first task message includes the guidance starting time (that is, the time point of generating the first movement time) and the scheduled stay time, the second navigation robot 120 can calculate a target arrival time by adding the guidance starting time and the scheduled stay time; however, the present invention is not limited to the example.

The second navigation robot 120 receives the time adjustment message transmitted from the first navigation robot 110, and adjusts the obtained target arrival time based on the received time adjustment message, for example, the second navigation robot 120 can increase or decrease the target arrival time by the adjustment time contained in the time adjustment message.

The second navigation robot 120 also determines whether it is able to reach a floor entry area of the second floor earlier than the target arrival time. When the second navigation robot 120 determines that it is unable to reach the floor entry area earlier than the target arrival time, the second navigation robot 120 calculates a delay time; when the second navigation robot 120 determine that it is able to reach the floor entry area earlier than the target arrival time, the second navigation robot 120 can generate the delay time with a value of zero. The second navigation robot 120 transmits the generated delay time to the first navigation robot 110. The floor entry area includes, but not limited to, an elevator entrance, an escalator entrance, or a stairwell.

When receiving the service instruction message transmitted from the first navigation robot 110, the second navigation robot 120 generates the second navigation route based on the second guidance message contained in the received first task message; that is, the second navigation robot 120 generates the second navigation route based on the information of the stay point contained in the second guidance message.

After receiving the service instruction message transmitted from the first navigation robot 110, the second navigation robot 120 moves to the floor entry area of the second floor to wait the service target 190 before the target arrival time. It is to be noted that the second navigation robot 120 can start moving the floor entry area after keeping standby to the certain time earlier than the target arrival time, when receiving the first task message, or after completing the current guidance task, but the present invention is not limited thereto.

The second navigation robot 120 can determine whether the service target 190 reaches the floor entry area of the second floor. For example, the second navigation robot 120 can determine whether the person reaching the second floor is the service target 190 by face recognition technology, so as to determine whether the service target 190 arrives; or the second navigation robot 120 can determine that the service target 190 arrives when the second navigation robot 120 can be connected to a wearable device with the tracker or the signal transmitter worn on the service target 190 or can detect the wearable device; otherwise, the second navigation robot 12 determines that the service target 190 does not arrive.

After determining that the service target 190 arrives, the second navigation robot 120 guides the service target 190 on the second floor based on the generated second navigation route, so as to guide service target 190 to the scheduled stay point of the second floor. After the service target 190 visits all of the scheduled stay points of the second floor, the second navigation robot 120 can guide the service target 190 to a floor departure area of the second floor. After determining that the service target 190 reaches the second floor, the second navigation robot 120 can generate and transmit the guidance starting message to the first navigation robot 110. In an embodiment, the guidance starting message includes the second navigation route and the guidance starting time generated by the second navigation robot 120.

When the practical stay time of the service target 190 for the scheduled stay point of the second floor is different from the expected stay time and/or the practical stay point is different from the scheduled stay point of the second navigation route, the second navigation robot 120 generates the time adjustment message including the adjustment time based on at least one of the practical stay time of the service target 190 at the stay point of the second floor and the location information about the stay point, and transmits the generated time adjustment message to the first navigation robot 110. The manner of generating the time adjustment message by the second navigation robot 120 is similar to the manner of the first navigation robot 110, so the detailed description is not repeated herein.

The second navigation robot 120 can determine that the service target 190 does not reach the floor entry area of the second floor, and generate and transmit an alarm message to the first navigation robot 110 when the second navigation robot 120 does not detect that the service target 190 reaches the floor entry area of the second floor at a certain time after the target arrival time, for example, the second navigation robot 120 detects absence of the wearable device worn on the service target 190 at the certain time after the target arrival time, or the second navigation robot 120 does not recognize the face of the service target 190, but the present invention is not limited thereto.

The third navigation robot 130 is disposed on the third floor and has a function similar to and operation the same as that of the second navigation robot 120, so the detailed description is not repeated herein.

It is to be noted that, in an embodiment of FIG. 1A, the second navigation robot 120 and the third navigation robot interact with the first navigation robot 110, but in another embodiment of the present invention, the first navigation robot 110, the second navigation robot 120 and the fourth navigation robot 140 are in communication with each other, as shown in FIG. 1B.

As shown in FIG. 1B, the fourth navigation robot 140 transmits the guidance data to the first navigation robot 110, the first navigation robot 110 obtains the guidance data by receiving the guidance data transmitted from the fourth navigation robot 140; when generating the first task message, the first navigation robot 110 generates the first task message including the guidance message of the floor other than the first floor in the guidance data, and the first floor is the floor where the first navigation robot 110 is disposed. Similarly, the second navigation robot 120 generates the second task message including the guidance message of the floor other than the first floor and the second floor, and transmits the second task message to the third navigation robot 130, and so on.

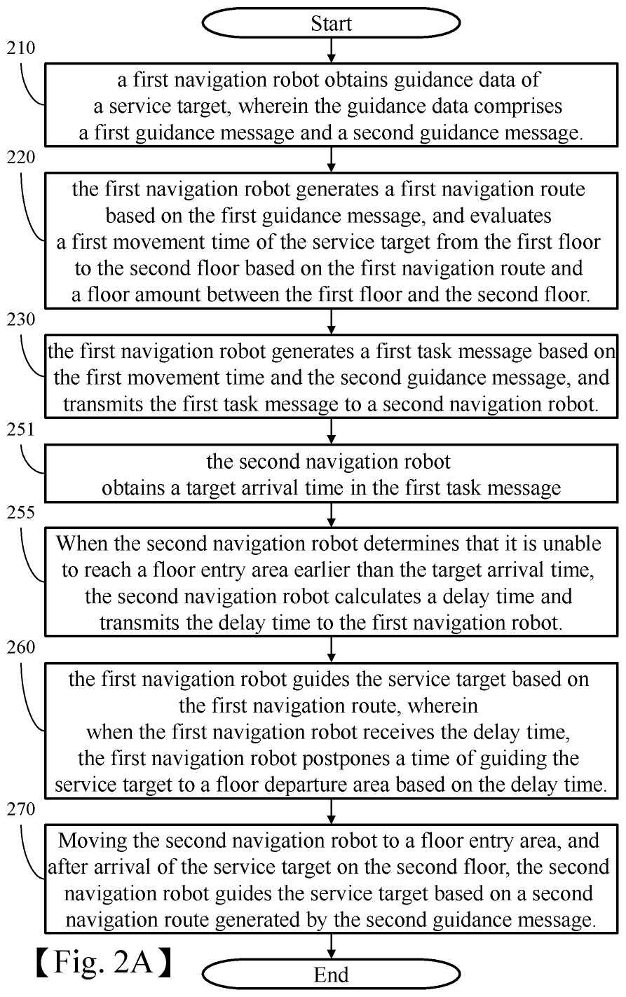

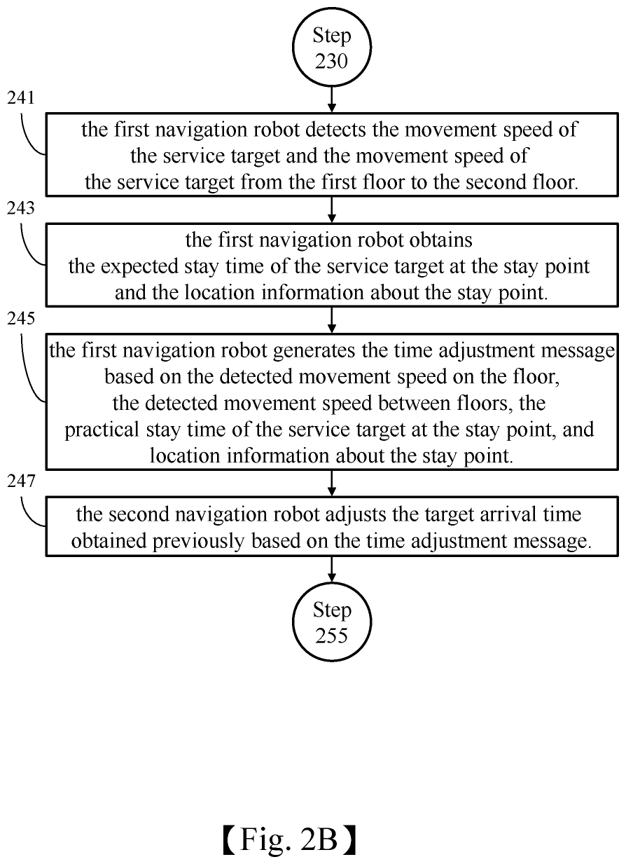

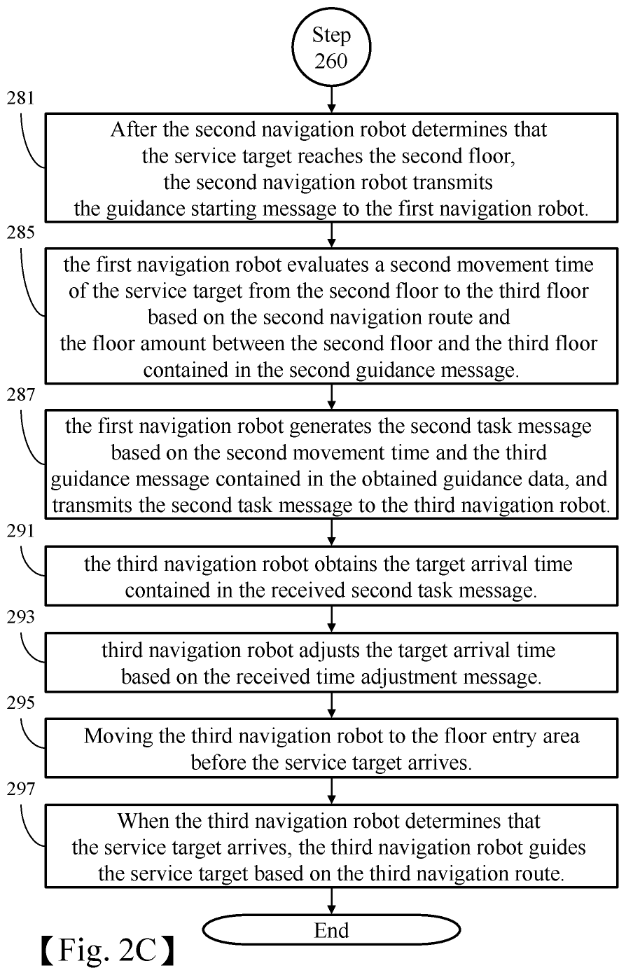

The operation of the system and the method of the present invention will be described with reference to an embodiment in the following paragraphs. Please refer to FIG. 2A, which is a flowchart of a method of cooperating with multiple navigation robots for cross-floor guidance based on time, according to the present invention. In this embodiment, the present invention is applied to an exhibition in which exhibits are displayed on multiple floors.

In a step 210, the first navigation robot 110 obtains the guidance data of the service target 190. In this embodiment, the service target 190 is at an entrance of the first building floor (such as the ground floor) of a building, the first navigation robot 110 provides the service target 190 to input the scheduled stay point, such as the exhibits in the exhibition halls on the second building floor and the fifth building floor; the first navigation robot 110 generates the guidance data including the first guidance message, the second guidance message, and the third guidance message based on the inputted scheduled stay points.

In a step 220, after the first navigation robot 110 generates the guidance data of the service target 190, the first navigation robot 110 generates the first navigation route based on the information of the stay point contained in the first guidance message, and evaluates the first movement time of the service target 190 from the first floor to the second floor based on the generated first navigation route and the floor amount between the first floor and the second floor. In this embodiment, since all of the scheduled stay points inputted by the service target 190 are not located on the first floor, it indicates that the service target 190 will directly leave the first floor, the first guidance message has no information about the stay points, the first navigation robot 110 sums up an average time of moving from a lobby to the elevator entrance (that is, the floor departure area) and the movement time (such as 3 minutes) of passing through single floor to calculate the scheduled stay time, so as to generate the first movement time.

In a step 230, after the first navigation robot 110 evaluates the first movement time, the first navigation robot 110 generates the first task message based on the first movement time and the second guidance message, and transmits the first task message to the second navigation robot 120 of the second floor corresponding to the second guidance message.

in a step 251, after the second navigation robot 120 receives the first task message transmitted from the first navigation robot 110, the second navigation robot 120 can obtain the target arrival time from the first task message.

After obtaining the target arrival time, the second navigation robot 120 determines whether it is able to reach the elevator entrance (that is, the floor entry area) of the second floor earlier than the target arrival time, and generates and transmits the corresponding delay time to the first navigation robot 110. When the second navigation robot 120 determines that it is able to reach the floor entry area earlier than the target arrival time, the second navigation robot 120 sets the delay time as zero; in a step 255, when the second navigation robot 120 determines that it is unable to reach the floor entry area earlier than the target arrival time, the second navigation robot 120 calculates the delay time and transmits the generated delay time to the first navigation robot 110.

In addition, after the first navigation robot 110 generates the first navigation route (the step 220), the first navigation robot 110 guides the service target 190 on the first floor based on the first navigation route. In this embodiment, the first navigation robot 110 can guide the service target 190 from a lobby to the elevator entrance (the floor departure area) of the ground floor, so that the service target 190 can take an elevator to the second floor; in addition, the first navigation robot 110 can guide the service target 190 from the lobby to the stairwell of the ground floor, so that the service target 190 can reach the second floor through the stairwell. In an embodiment, the first navigation robot can apply a positioning technology to continuously detect a practical position of a band (that is, a wearable device) worn on the service target 190, or perform face recognition on a face image of the service target 190 captured by an image capture device disposed in the stairwell, so as to determine the practical position of the service target 190 and further calculate the movement speed of the service target 190 between the floors. In an embodiment, the service target 190 obtains the band when entering the exhibition building.

In a step 260, during the process in which the first navigation robot 110 guides the service target 190 on the first floor, when the first navigation robot 110 receives the delay time transmitted from the second navigation robot 120, the first navigation robot 110 determines whether to postpone the time of guiding the service target 190 to the floor departure area of the first floor based on the received delay time. In this embodiment, when the first navigation robot 110 receives the delay time with a value of zero, the first navigation robot 110 can first select the second navigation robot 120 which transmits the delay time with the value of zero, and transmit the service instruction message to the selected second navigation robot 120; when all of the delay times transmitted from the second navigation robots 120 are not zero, the first navigation robot 110 selects the second navigation robot 120 which transmits the shortest delay time, and transmits the service instruction message to the selected second navigation robot 120, and postpones the time of guiding the service target to the elevator entrance of the first floor based on the delay time.

After receiving the service instruction message transmitted from the first navigation robot 110, the second navigation robot 120 can reach the floor entry area of the second floor earlier than the target arrival time to wait the service target 190 at the floor entry area of the second floor, and continuously check whether the service target 190 reaches the second floor. In this embodiment, in a condition that the service target 190 wears the band provided when the service target 190 enters the exhibition building, when the second navigation robot 120 detects or connects to the band worn on the service target 190 after the door of the elevator which the service target 190 takes opens or the service target 190 walks to the second floor through the stairwell, the second navigation robot 120 can determine that the service target 190 reaches the floor entry area of the second floor. When the second navigation robot 120 detects absence of the band worn on the service target 190 at a certain time after the target arrival time, the second navigation robot 120 determines that the service target 190 does not reach the second floor, and generates and transmits the alarm message to the first navigation robot 110.

In a step 270, after the second navigation robot 120 determines that the service target 190 reaches the second floor, the second navigation robot 120 guides the service target 190 on the second floor based on the second navigation route generated by the second guidance message. In this embodiment, the second navigation robot 120 can learn about the specific exhibit which the service target 190 is to visit on the second floor based on the information of the stay point contained in the second guidance message, and guide the service target 190 to the exhibit to be visited from the elevator entrance of the second floor, and display or broadcast the data related to the exhibit to be visited. After the service target 190 has visited the exhibits already, the second navigation robot 120 guides the service target 190 to the elevator entrance (the floor departure area) of the second floor.

As a result, the technical solution of the present invention can facilitate the service target to seamlessly obtain the guiding services of the navigation robots on different floors without waiting.

As shown in FIG. 2B, in the process of the above-mentioned embodiment, in a step 241, after the first navigation robot 110 transmits the first task message to the second navigation robot 120, the first navigation robot 110 detects at least one of the movement speed of the service target 190 on the first floor and the movement speed of the service target 190 from the first floor to the second floor. In a step 243, the first navigation robot 110 can obtain the expected stay time of the service target 190 at the stay point (such as the scheduled stay point and the exceptional stay point) and the location information about the stay point; in a step 245, the first navigation robot 110 generates the time adjustment message based on at least one of the detected movement speed on the floor, the detected movement speed between floors, the practical stay time of the service target 190 at the stay point, and location information about the stay point.

In a step 247, the first navigation robot 110 transmits the generated time adjustment message to the second navigation robot 120, and the second navigation robot 120 adjusts the target arrival time obtained previously based on the time adjustment message after receiving the time adjustment message. In a step 255, the second navigation robot 120 determines whether it is able to reach the floor entry area of the second floor earlier than the target arrival time, and the second navigation robot 120 generates and transmits the delay time to the first navigation robot 110, so that the first navigation robot 110 can re-select one of the second navigation robots 120 based on the delay times, and determine whether to postpone the time of guiding the service target 190 to the floor departure area of the first floor based on the delay time transmitted from the selected second navigation robot 120 (the step 260).

As shown in FIG. 2C, in a process of the above-mentioned embodiment, in step 281, after the second navigation robot 120 determines that the service target 190 reaches the second floor, the second navigation robot 120 transmits the guidance starting message to the first navigation robot 110.

in a step 285, after receiving the guidance starting message transmitted from the second navigation robot 120, the first navigation robot 110 can evaluate a second movement time of the service target 190 from the second floor to the third floor based on the second navigation route and the floor amount between the second floor and the third floor contained in the second guidance message. Next, in a step 287, the first navigation robot 110 generates the second task message based on the evaluated second movement time and the third guidance message contained in the obtained guidance data, and transmits the generated second task message to the third navigation robot 130.

In a condition that the second navigation robot 120 is able to directly transmit the message to the third navigation robot 130, the second navigation robot 120 does not need to transmit the message through first navigation robot 110; after determining that the service target 190 reaches the second floor, the second navigation robot 120 evaluates the second movement time of the service target 190 from the second floor to the third floor based on the second navigation route and the floor amount between the second floor and the third floor contained in the second guidance message, generates the second task message based on the evaluated second movement time and the third guidance message contained in the first task message, and transmits the generated second task message to all of the third navigation robots 130.

In a step 291, after receiving the second task message transmitted from the first navigation robot 110 or the second navigation robot 120, the third navigation robot 130 obtains the target arrival time contained in the received second task message; in a step 295, the third navigation robot 130 reaches the floor entry area of the third floor to wait the service target 190 before the target arrival time (that is, before the service target 190 reaches the third floor). The third navigation robot 130 can determine whether it is able to reach the floor entry area of the third floor earlier than the target arrival time, and transmits the generated delay time to the first navigation robot 110 (or the second navigation robot 120), the first navigation robot 110 selects one of the third navigation robots 130 based on the received delay time, and forwards the delay time, which is transmitted from the selected third navigation robot 130, to the second navigation robot 120; or the second navigation robot 120 selects one of the third navigation robots 130 based on the received delay time.

After the selected third navigation robot 130 receives the service instruction message transmitted from the first navigation robot 110 or the second navigation robot 120 and obtains the target arrival time (the step 291), and before the selected third navigation robot 130 reaches the floor entry area of the third floor (the step 295), when the second navigation robot 120 guides the service target 190 based on the second navigation route (the step 270) but the action of the service target 190 does not match the second navigation route (for example, the practical stay time of the service target 190 at the scheduled stay point is different from the expected stay time, and/or the stay location is different from the scheduled stay point of the second navigation route), the second navigation robot 120 can generate the time adjustment message, and directly transmit the time adjustment message to the selected third navigation robot 130 or indirectly transmit to the selected third navigation robot 130 through the first navigation robot 110 (that is, the first navigation robot 110 forwards the time adjustment message). For example, the operation of generating the time adjustment message by the second navigation robot 120 can be the same as the process shown in FIG. 2B. In a step 293, the third navigation robot 130 can adjust the target arrival time based on the received time adjustment message, so as to reach the floor entry area of the third floor earlier than the adjusted target arrival time.

After the selected third navigation robot 130 receives the service instruction message transmitted from the first navigation robot 110 or the second navigation robot 120 and reaches the floor entry area of the third floor earlier than the target arrival time (the step 295), the third navigation robot 130 determines whether the service target 190 reaches the third floor. In a step 297, when the third navigation robot determines that the service target 190 reaches the floor entry area of the third floor, the third navigation robot 130 guides the service target 190 on the third floor based on the third navigation route generated by the third guidance message.

According to above-mentioned contents, the difference between the present invention and conventional technology is that the first navigation robot evaluates the first movement time of the service target from the first floor to the second floor based on the first navigation route of the first floor and the floor amount between the first floor and the second floor, and generates the first task message based on the first movement time and the second guidance message of the second floor, and guides the service target on the first floor; the second navigation robot obtains the target arrival time contained in the first task message, calculates and transmits the delay time to the first navigation robot when determining that it is unable to reach the floor entry area of the second floor earlier than the target arrival time, so that the first navigation robot can postpone the time of guiding the service target to the floor departure area of the first floor based on the delay time; after the second navigation robot determines that the service target reaches the second floor, the second navigation robot can guide the service target on the second floor based on the second navigation route generated by the second guidance message. As a result, the above-mentioned technical solution of the present invention can solve the conventional technology problem of lacking cooperative communication mechanism for the navigation robot disposed on different floors, so as to achieve the technical effect of shortening the guidance waiting time for the service target.

Furthermore, the method of the present invention, can be implemented by hardware, software or a combination thereof, and can be implemented in a computer system by a centralization manner, or by a distribution manner of different components distributed in several interconnect computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of cooperating with multiple navigation robots for cross-floor guidance based on time, comprising:
obtaining guidance data of a service target, by a first navigation robot of a first floor, wherein the guidance data comprises a first guidance message of the first floor and a second guidance message of a second floor;
generating a first navigation route based on the first guidance message, and evaluating a first movement time of the service target from the first floor to the second floor based on the first navigation route and a floor amount between the first floor and the second floor, generating a first task message based on the first movement time and the second guidance message, and transmitting the first task message to a second navigation robot of the second floor, by the first navigation robot;
obtaining a target arrival time in the first task message, by the second navigation robot wherein when the second navigation robot determines that it is unable to reach a floor entry area of the second floor earlier than the target arrival time, the second navigation robot calculates a delay time and transmits the delay time to the first navigation robot;
guiding the service target on the first floor based on the first navigation route, by the first navigation robot, wherein when the first navigation robot receives the delay time, the first navigation robot postpones a time of guiding the service target to a floor departure area of the first floor based on the delay time;
moving the second navigation robot to a floor entry area of the second floor; and
after arrival of the service target on the second floor, guiding the service target on the second floor based on a second navigation route generated by the second guidance message, by the second navigation robot.

2. The method of cooperating with multiple navigation robots for cross-floor guidance based on time according to claim 1, before the step of guiding the service target on the second floor based on the second navigation route by the second navigation robot, further comprising:
transmitting a guidance starting message to the first navigation robot, by the second navigation robot;
evaluating a second movement time of the service target from the second floor to the third floor based on the second navigation route and a floor amount between the second floor and the third floor, generating a second task message based on the second movement time and a third guidance message of the third floor contained in the guidance data, and transmitting the second task message to a third navigation robot of the third floor, by the first navigation robot.

3. The method of cooperating with multiple navigation robots for cross-floor guidance based on time according to claim 2, after the step of transmitting the guidance starting message to the first navigation robot by the second navigation robot, further comprising:
generating and transmitting a time adjustment message to the first navigation robot, by the second navigation robot;
transmitting the time adjustment message to the third navigation robot, by the first navigation robot; and
adjusting the time of moving to a floor entry area of the third floor based on the time adjustment message, by the third navigation robot.

4. The method of cooperating with multiple navigation robots for cross-floor guidance based on time according to claim 1, wherein the step of obtaining the guidance data of the service target by the first navigation robot comprises:
receiving the guidance data transmitted from a navigation setting device or a fourth navigation robot of a fourth floor, or generating the guidance data based on a scheduled stay point inputted by the service target.

5. The method of cooperating with multiple navigation robots for cross-floor guidance based on time according to claim 1, after the step of moving the second navigation robot to the floor entry area of the second floor, further comprising:
when the service target does not arrive at a certain time after the target arrival time, generating and transmitting an alarm message to the first navigation robot, by the second navigation robot.

6. The method of cooperating with multiple navigation robots for cross-floor guidance based on time according to claim 1, after the step of evaluating the first movement time of the service target from the first floor to the second floor based on the first navigation route and the floor amount between the first floor and the second floor, by the first navigation robot, further comprising:
generating a time adjustment message based on at least one of the movement speed of the service target on the first floor and the movement speed of the service target from the first floor to the second floor, and transmitting the time adjustment message to the first navigation robot, by the first navigation robot, wherein the first navigation robot detects or predicts the movement speed of the service target from the first floor to the second floor; and
adjusting the target arrival time based on the time adjustment message, by the second navigation robot.

7. The method of cooperating with multiple navigation robots for cross-floor guidance based on time according to claim 6, wherein the step of detecting the movement speed between floors of the service target from the first floor to the second floor, by the first navigation robot, comprises:
continuously determining a practical position of the service target by positioning a wearable device worn on the service target, and calculating a movement speed based on the practical position, by the first navigation robot.

8. The method of cooperating with multiple navigation robots for cross-floor guidance based on time according to claim 1, wherein the step of guiding the service target on the first floor based on the first navigation route by the first navigation robot, comprises:
when the first navigation robot passes through a scheduled stay point recorded in the first guidance message and an exceptional stay point where the service target additionally stays, calculating a time adjustment message based on at least one of the first navigation route, and a stay time of the service target at the scheduled stay point and the exceptional stay point, and location information of the scheduled stay point and the exceptional stay point, and transmitting the time adjustment message to the second navigation robot, by the first navigation robot; and
adjusting the target arrival time based on the time adjustment message, and determining whether the second navigation robot is able to reach a floor entry area of the second floor earlier than the target arrival time.

9. A system of cooperating with multiple navigation robots for cross-floor guidance based on time, comprising:
a first navigation robot configured to obtain guidance data of a service target, wherein the guidance data comprises a first guidance message of a first floor, and a second guidance message of a second floor, and the first navigation robot generates a first navigation route based on the first guidance message, evaluates a first movement time of the service target from the first floor to the second floor based on the first navigation route and a floor amount between the first floor and the second floor, and generate a first task message based on the first movement time and the second guidance message, and guides the service target on the first floor based on the first navigation route; and
a second navigation robot configured to receive the first task message transmitted from the first navigation robot, obtain a target arrival time contained in the first task message, and determine whether it is able to reach a floor entry area of the second floor earlier than the target arrival time, calculate and transmit a delay time to the first navigation robot, so that the first navigation robot postpones a time of guiding the service target to a floor departure area of the first floor based on the delay time, wherein the second navigation robot moves to a floor entry area of the second floor, and guides the service target on the second floor based on a second navigation route generated by the second guidance message, after arrival of the service target.

10. The system of cooperating with multiple navigation robots for cross-floor guidance based on time according to claim 9, further comprising a third navigation robot, wherein the second navigation robot transmits a guidance starting message to the first navigation robot, the first navigation robot evaluates a second movement time of the service target from the second floor to the third floor based on the second navigation route and a floor amount between the second floor and the third floor, and generates a second task message based on the second movement time and a third guidance message of the third floor in the guidance data, and transmits the second task message to the third navigation robot of the third floor.

11. The system of cooperating with multiple navigation robots for cross-floor guidance based on time according to claim 10, wherein the second navigation robot generates and transmits the time adjustment message to the first navigation robot, the first navigation robot transmits a time adjustment message to the third navigation robot, and the third navigation robot adjusts the time of moving to a floor entry area of the third floor based on the time adjustment message.

12. The system of cooperating with multiple navigation robots for cross-floor guidance based on time according to claim 9, wherein the first navigation robot obtains the guidance data by receiving the guidance data transmitted from a navigation setting device or a fourth navigation robot of a fourth floor, or generating the guidance data based on a scheduled stay point inputted by the service target.

13. The system of cooperating with multiple navigation robots for cross-floor guidance based on time according to claim 9, wherein when determining that the service target does not arrive at a certain time after the target arrival time, the second navigation robot generates and transmits an alarm message to the first navigation robot.

14. The system of cooperating with multiple navigation robots for cross-floor guidance based on time according to claim 9, wherein the first navigation robot generates a time adjustment message based on at least one of the movement speed of the service target on the first floor and the movement speed of the service target from the first floor to the second floor, and the first navigation robot predicts or detects the movement speed of the service target from the first floor to the second floor;
wherein the first navigation robot transmits the time adjustment message to the second navigation robot, and the second navigation robot adjusts the target arrival time based on the time adjustment message.

15. The system of cooperating with multiple navigation robots for cross-floor guidance based on time according to claim 14, wherein the first navigation robot determines a practical position of the service target by continuously positioning a wearable device worn on the service target, and predicts or detects the movement speed of the service target on the floor based on the practical position.

16. The system of cooperating with multiple navigation robots for cross-floor guidance based on time according to claim 9, wherein when the first navigation robot passes through a scheduled stay point recorded in the first guidance message and an exceptional stay point where the service target additionally stays, the first navigation robot calculates a time adjustment message based on at least one of the first navigation route and a stay time of the service target at the scheduled stay point and the exceptional stay point and location information of the scheduled stay point and the exceptional stay point, and transmits the time adjustment message to the first navigation robot, and the second navigation robot adjusts the target arrival time based on the time adjustment message and determines whether it is able to reach a floor entry area of the second floor earlier than the target arrival time, and when the second navigation robot determines that it is unable to reach the floor entry area of the second floor earlier than the target arrival time, the second navigation robot transmits the delay time to the first navigation robot.
